(19) United States
(12) Patent Application Publication
(10) Pub. No.: US 2011/0219094 A1
(43) Pub. Date: Sep. 8, 2011

(54) METHOD AND MACHINE FOR AUTOMATICALLY GENERATING ONE OR MORE AGGREGATED FEEDS WITHIN A NETWORK

(76) Inventor: Bhavin Turakhia, Mumbai (IN)

(21) Appl. No.: 12/772,278

(22) Filed: May 3, 2010

(30) Foreign Application Priority Data
Mar. 5, 2010 (IN) 598/MUM/2010

(51) Int. Cl. G06F 15/16

(52) U.S. Cl. 709/217

(57) ABSTRACT

The present invention relates to method and machine for automatic generation of aggregated feeds within a network. The method includes storing attribute values of entities and content associated with entities within the network. An aggregated feed is formed by creating combinations of the attribute values and generating an aggregated feed for each attribute value combination. For generating an aggregated feed, content associated with entities that have at least one attribute value matching at least one attribute value from an attribute value combination is determined and added to the aggregated feed. The aggregated feed is displayed to an entity that has the attribute value combination for which the aggregated feed is generated. The present invention also related to method and machine for automatic generation of geo-aggregated feed for an entity. The method includes storing location attribute values of entities and content associated with entities within the network. A request is received from an entity for a geo-aggregated feed. A geo-aggregated feed is formed by determining content associated with entities that are within predetermined distance from the location of the entity and adding the content to the geo-aggregated feed.

### FIELD OF THE INVENTION

The invention relates generally to content syndication and specifically, to a machine for automatically generating aggregated feeds for entities within a network.

### BACKGROUND OF THE INVENTION

Internet is rapidly taking over Television, print and radio as the foremost media to render updated and targeted content to its users. Internet users constantly access websites, news and blog postings on the Internet, either by proactively visiting the relevant Uniform Resource Links (URLs) or by subscribing to content feeds from specific websites.

Current systems allow users to access content in formats such as Really Simple Syndication (RSS) or Atom where a user is required to subscribe to these content feeds using an application known as a ‘reader’ or ‘aggregator’. Any updates to the content feeds are reflected in the user's ‘reader’.

More recent products, such as Twitter, Facebook etc allow require users to subscribe to each other's feeds to receive updates from their social network.

These systems require a user to proactively subscribe to all the feeds that the user might be interested in. Further, in case of RSS/Atom feeds, the user's aggregator aggregates content only from those websites that have RSS or Atom capability.

One of the challenges faced by any network is that of determining useful or relevant content that a user might be interested in viewing.

Hence, there is a need for a method and a machine that automatically provides a user with a relevant content feed that the user might be interested in, without having the user to manage his content feed proactively.

### BRIEF DESCRIPTION OF THE FIGURES

The accompanying figures, where like reference numerals refer to identical or functionally similar elements throughout the separate views and which together with the detailed description below are incorporated in and form part of the specification, serve to further illustrate various embodiments and to explain various principles and advantages all in accordance with the invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the invention.

FIG. 1 illustrates a block diagram of an exemplary environment for automatic generation of one or more aggregated feeds within a network in accordance with various embodiments of the present invention.

FIG. 2 illustrates a flow diagram of a method for automatically generating one or more aggregated feeds within a network in accordance with an embodiment of the present invention.

FIG. 3 illustrates a block diagram of a machine for automatically generating one or more aggregated feeds within a network in accordance with an embodiment of the present invention

FIG. 4 illustrates a block diagram of an exemplary environment for automatic generation of a geo-aggregated feed within a network in accordance with various embodiments of the present invention.

FIG. 5 illustrates a flow diagram of a method for automatically generating a geo-aggregated feed for an entity within a network in accordance with an embodiment of the present invention.

FIG. 6 illustrates a block diagram of a machine for automatically generating a geo-aggregated feed for an entity within a network in accordance with an embodiment of the present invention.

### DETAILED DESCRIPTION OF THE INVENTION

Before describing in detail embodiments that are in accordance with the invention, it should be observed that the embodiments reside primarily in combinations of method steps and machine components related to automatically generating one or more aggregated feeds within a network. Accordingly, the machine components and method steps have been represented where appropriate by conventional symbols in the drawings, showing only those specific details that are pertinent to understanding the embodiments of the invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or machine that comprises a list of elements does not include only those elements but may include other elements not expressly listed or inherent to such process, method, article, or machine. An element proceeded by “comprises . . . a” does not, without more constraints, preclude the existence of additional identical elements in the process, method, article, or machine that comprises the element.

It will be appreciated that embodiments of the invention described herein may be comprised of one or more conventional processors and unique stored program instructions that control the one or more processors to implement, in conjunction with certain non-processor circuits, some, most, or all of the functions for automatically generating one or more aggregated feeds within a network described herein. The non-processor circuits may include, but are not limited to, a radio receiver, a radio transmitter, signal drivers, clock circuits, power source circuits, and user input devices. As such, these functions may be interpreted as steps of a method for automatically generating one or more aggregated feeds within a network. Alternatively, some or all functions could be implemented by a state machine that has no stored program instructions, or in one or more Application Specific Integrated Circuits (ASICs), in which each function or some combinations of certain of the functions are implemented as custom logic. Of course, a combination of the two approaches could be used. Thus, methods and means for these functions have been described herein. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The present invention relates generally to content syndication within a network such as a social collaboration network, corporate collaboration network etc. Those skilled in the art will appreciate that the present invention can be easily extended to any network of computing devices that are operatively connected to each other.

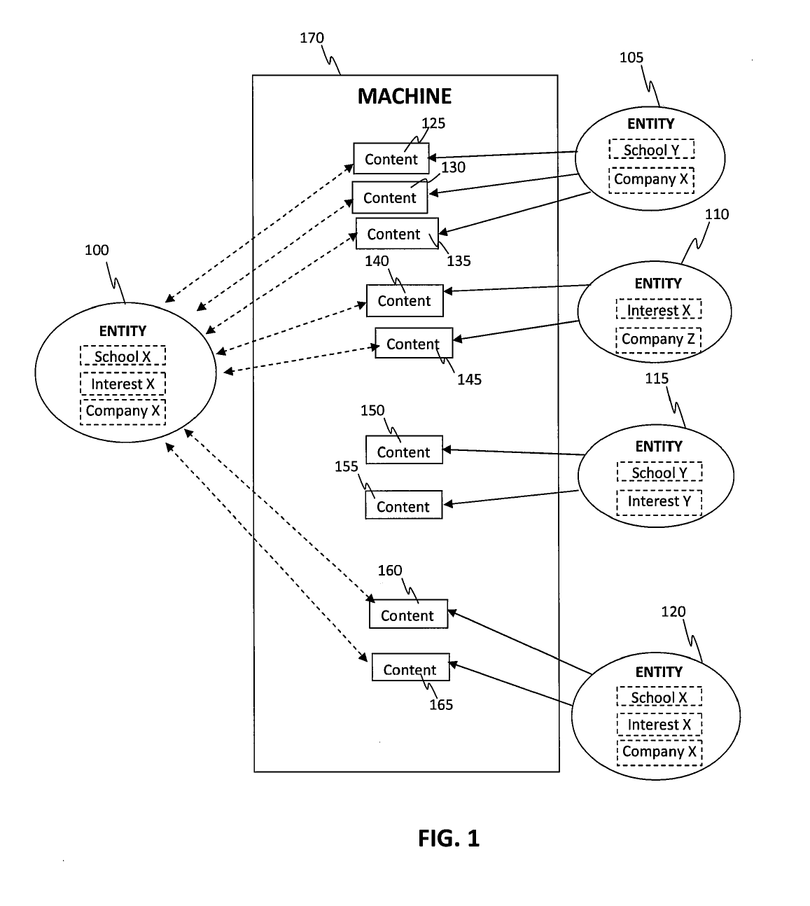

Referring to FIG. 1, a block diagram of an exemplary environment for automatic generation of one or more aggregated feeds within a network is shown in accordance with various embodiments of the present invention. The network can have a plurality of entities registered with it. An entity, in accordance with the present invention can be, but is not limited to a user, a user group, an organization, a company, a device, an institution or an application.

As depicted in FIG. 1, the network comprises of an Entity 100, an Entity 105, an Entity 110, an Entity 115 and an Entity 120. Those skilled in the art will appreciate that the network can include a plurality of entities. However, only four entities are shown in FIG. 1 for the sake of clarity. Each entity can have various attributes associated with it. For instance, if an entity is a user, the user can specify his educational institutions, a company that the user works for, the user's interests etc while registering with the network. In accordance with the present invention, the educational institution, the company and the interests specified by the user are the attributes associated with the user. If the user graduated from the Stanford, works for the company Directl and interests include travelling and reading, then in accordance with the present invention, ‘Stanford’ is an attribute value for the ‘school’ attribute for the user, ‘Directl’ is an attribute value for the ‘company’ attribute for the user and ‘travelling’ and ‘reading’ are the attribute values for the ‘interests’ attribute for the user.

Further, each attribute can have more than one attribute values for a particular entity. For instance, the user can have more than one company in the company attribute values, including the user's present and past companies. Similarly, the user can have more than one school attribute values associated with him, including current and previous schools attended.

Those skilled in the art will appreciate that the ‘school’, ‘interest’ and ‘company’ attributes are only exemplary and any attributes are within the scope of the present invention.

In accordance with FIG. 1, Entity 100 has attribute values ‘School X’, ‘Interest X’ and ‘Company X’ associated with it. Similarly, Entity 105 has attribute values ‘School Y’ and ‘Company X’ associated with it. Entity 110 has attribute values ‘Interest X’ and ‘Company Z’ associated with it. Entity 115 has attribute values ‘School Y’ and ‘Interest Y’ associated with it. Entity 120 has attribute values ‘School X’, ‘Interest X’ and ‘Company X’ associated with it.

Hence, in accordance with the present exemplary embodiment, Entity 100 shares its ‘company’ attribute value with Entity 105, namely ‘Company X’; its ‘interest’ attribute value with Entity 110, namely ‘Interest X’; its ‘school’, ‘interest’ and ‘company’ attribute values with Entity 120, namely ‘School X’, ‘Interest X’ and ‘Company X’. Entity 100 does not have any attribute value in common with Entity 115.

Those skilled in the art will know that each entity in the network can have various content associated with it. For instance, an entity can either publish or subscribe to content in the form of, but not limited to, a microblog post, a blog post, an update, a file upload, a comment, a photo, a media file, a presentation, a document, a message, an application and a news feed.

An entity is usually associated with content that is relevant to or of interest to that entity. The present invention enables the network to automatically determine the content that an entity might be interested in and displays this content in the form of an aggregated feed to an entity.

Referring back to FIG. 1, Entity 105 can have a Content 125, a Content 130 and a Content 135 associated with it. For instance, Content 125 can be a blog post of Entity 105, Content 130 can be a news feed that Entity 105 subscribes to and Content 135 can be photos uploaded by Entity 105. Similarly, Entity 110 can have a Content 140 and a Content 145 associated with it. For instance, Content 140 can be an application used by Entity 110 and Content 145 can be a message posted by Entity 110 on a public forum. Entity 115 can have a Content 150 and a Content 155 associated with it. Content 150 can be a news feed that Entity 115 is subscribed to and content 155 can be a video uploaded by Entity 115. Entity 120 can have a Content 160 and a Content 165 associated with it. Content 160 can be a video clip recommended by Entity 120 and content 165 can be a weather report subscribed to by Entity 120.

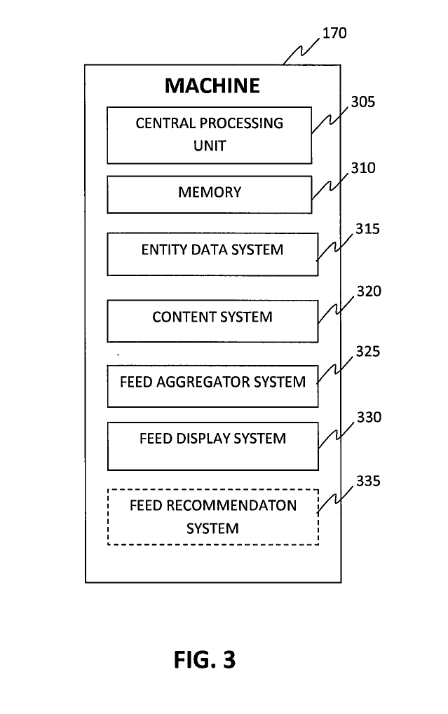

In accordance with the present invention, Machine 170 is configured to automatically detect content that is relevant to Entity 100 from Content 125, Content 130, Content 135, Content 140, Content 145, Content 150, Content 155, Content 160 and Content 165. Various components of Machine 170 are described below in detail in conjunction with FIG. 3.

For this, Machine 170 determines one or more entities within the network whose attribute values match the attribute values of Entity 100 and aggregates content that the one or more entities are associates with. This content is deemed relevant to Entity 100.

For instance, Machine 170 determines that Content 125, Content 130 and Content 135 are relevant to Entity 100 since Entity 100 and Entity 105 are from the same company, namely Company X. Similarly, Machine 170 determines that Content 140 and Content 145 are relevant to Entity 100 since Entity 100 and Entity 110 have the same interest, namely Interest X. Machine 170 will recognize that Content 150 and Content 155 are not relevant to Entity 100 since Entity 100 and Entity 115 do not have any attribute values in common. Machine 170 will recognize Content 160 and Content 165 as being relevant to Entity 100 since Entity 100 and Entity 120 are from the same school, namely School X, have the same interest, namely X, and are from the same company, namely Company X.

In an embodiment of the present invention, Machine 170 aggregates Content 125, Content 130, Content 135, Content 140, Content 145, Content 160 and Content 165 into an aggregated feed for Entity 100, which is rendered to Entity 100 on its display device automatically.

In one embodiment of the present invention, Machine 170 considers content to be relevant to Entity 100 if more than one attribute value is shared between Entity 100 and other entities.

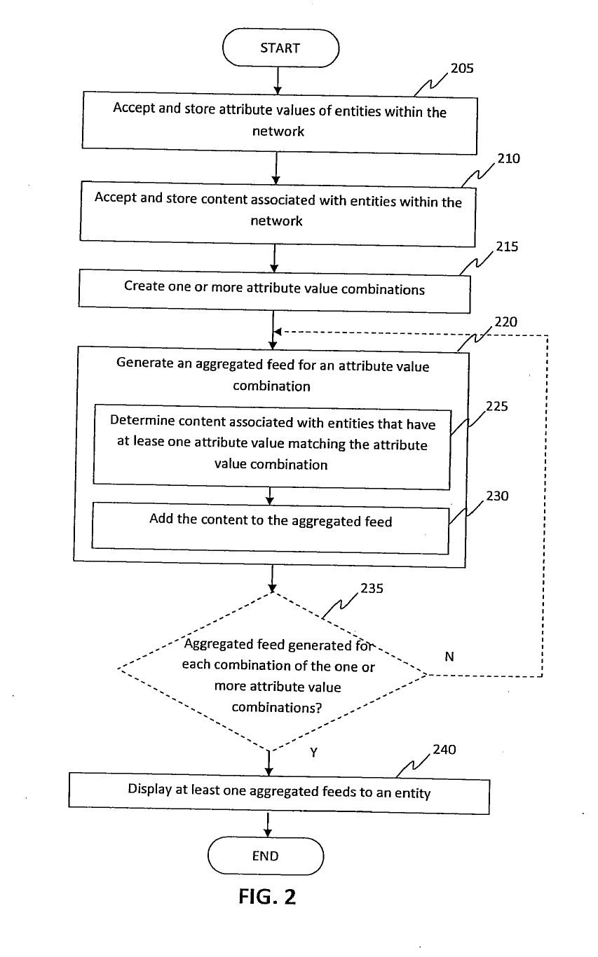

Turning now to FIG. 2, a flow diagram of a method for automatically generating one or more aggregated feeds within the network is shown in accordance with an embodiment of the present invention. The present embodiment describes a method for aggregating relevant content feed for Entity 100 of FIG. 1.

As mentioned in conjunction with FIG. 1, an entity within the network can have various attributes associated with it. One or more attribute values for one or more attributes are accepted from one or more entities within the network and these attribute values are stored at step 205. The attributes can be, but are not limited to, one or more personal attributes of the entity, one or more geographical attributes of the entity, one or more educational attributes of the entity, one or more group attributes of the entity, one or more work attributes of the entity, one or more skill attributes of the entity and one or more interest attributes of the entity.

The personal attributes of an entity can include, but is not limited to, one or more combinations of one or more names of the entity, an age of the entity, a birthday of the entity, a gender of the entity, a nationality of the entity, one or more websites of the entity, one or more Instant messenger details of the entity, one or more email address of the entity and one or more relationship status of the entity.

The geographical attributes of an entity can include, but is not limited to, one or more combinations of countries associated with the entity, states associated with the entity, cities associated with the entity, suburbs associated with the entity, streets associated with the entity, pin codes associated with the entity, latitude, longitude or altitude associated with the entity, and buildings associated with the entity.

The educational attributes of an entity can include, but is not limited to, one or more combinations of qualifications of the entity, schools of the entity, classes corresponding to the schools of the entity and degrees acquired by the entity.

The group attributes of an entity can include, but is not limited to groups and geographical attributes of the groups in the network that the entity is subscribed to or associated with.

The work attributes of an entity can include, but is not limited to, one or more combinations of companies of the entity, geographical attributes of the companies of the entity, departments within the companies that the entity is associated with, professions of the entity, occupations of the entity and industries related to the entity.

The interest attributes of an entity can include interests of the entity and the skill attributes of an entity can include specializations of the entity.

In accordance with an embodiment of the present invention, each entity has an entity ID within the network. The attribute values for a particular entity are stored against that entity's entity ID. For instance, Entity 100 can have entity ID ‘XYZ123’ within the network. Attribute values associated with Entity 100 can be stored against the ID ‘XYZ123’. Hence, attribute value ‘School X’ for the ‘school’ attribute, attribute value ‘Interest X’ for the ‘interest’ attribute and attribute value ‘Company X’ for the ‘company’ attribute are stored against the entity ID ‘XYZ123’.

Those skilled in the art will appreciate that the attribute values can be stored using any method known in the art and all such methods are within the scope of the present invention.

At step 210, one or more content associated with a plurality of entities within the network are accepted and stored. T hose skilled in the art will appreciate that, one or more content IDs can be stored instead of storing the one or more content so as to optimize memory space usage.

In accordance with an embodiment of the present invention, the one or more content or one or more content IDs are stored against the entity IDs. For instance, if Entity 105 has an entity ID ABC123, then Content 125, Content 130 and Content 135 or their respective content IDs can be stored against the entity ID ABC123. It will be appreciated that a content can have more than one entity associated with it, depending on the number of entities that are subscribed to or generate the content.

At step 215, one or more attribute value combinations are created. For instance, referring back to FIG. 1, all combinations of attribute values School X, School Y, Interest X, Interest Y, Company X and Company Z, are created at step 215.

At step 220, an aggregated feed is generated for an attribute value combination created at step 215. An aggregated feed comprises content aggregated from entities with one or more attribute values matching the attribute value combination in consideration.

For generating an aggregated feed for an attribute value combination, content associated with entities that have at least one attribute value matching the attribute value combination is determined, at step 225. For instance, for the attribute value combination of School X, Interest X and Company X, entities are identified that have at least one of these attribute values. In accordance with FIG. 1, Entity 105, Entity 110 and Entity120 have at least one attribute values from the attribute value combination of School X, Interest X and Company X. Step 225 includes determining content that is associated with Entity 105, Entity 110 and Entity120. Hence, Content 125, Content 130, Content 135, Content 140, Content 145, Content 160 and Content 165 are determined and added, at step 230, to the aggregated feed for the attribute value combination of School X, Interest X and Company X. Those skilled in the art will realize that instead of the content itself, a marker or a content ID of the content can be added to the aggregated feed.

In an embodiment of the present invention, it is checked if an aggregated feed is created for each combination of all the attribute value combinations possible at step 235. In another embodiment, an aggregated feed is created for only specific attributes or attribute combinations. For instance, an aggregated feed can be created only for the Interest attribute.

In an embodiment of the present invention, an entity is given an option to subscribe or unsubscribe from the aggregated feed. In another embodiment, an entity is given an option to subscribe to aggregated feed for specific combinations of attributes. For instance, the entity can be given one or more filter options for receiving the aggregated feed. The one or more filter options include, but are not limited to, filtering the aggregated feed by at least one attribute, filtering the aggregated feed by at least one entity type, filtering the aggregated feed by at least one entity, and filtering the aggregated feed by at least one type of content. Entity type includes, but is not limited to, a user, a user group, an organization, a company, a device and an application.

In another embodiment of the present invention, content included in the aggregated feed has one or more permissions attached. The one or more permissions can allow or disallow an entity or an entity group to view the content. Any content that an entity does not have permission to view, is filtered out from the aggregated feed.

In an embodiment of the present invention, content in the aggregated feed is ordered in terms of priority either specified by the entity or a default priority. The priority can be based on, but not limited to, the attributes, number of attribute values that the entity shares with entities with whom the content is associated, content type etc.

For instance, in the aggregated feed for Entity 100, Content 160 and Content 165 can be ordered before Content 125, Content 130, Content 135, Content 140 and Content 145 since, Entity 100 and Entity 120 have the maximum attribute values matching.

Those skilled in the art will realize that many such embodiments to prioritize and filter the aggregated feed can be derived, and all such embodiments are within the scope of the present invention.

At step 240, the aggregated feed is displayed to an entity. In accordance with the exemplary embodiment depicted in FIG. 1, an aggregated feed comprising Content 125, Content 130, Content 135, Content 140, Content 145, Content 160 and Content 165 is displayed to Entity 100.

The aggregated feed can be displayed within a browser window of Entity 100 or alongside the browser, as a separate window. Alternately, the aggregated feed can also be displayed as a set of hyperlinks linking to each content within the aggregated feed.

Those skilled in the art will appreciate that the aggregated feed being displayed to an entity does not indicate that the content within the aggregated feed is ‘associated’ with the entity. Hence, while generating an aggregated feed, only the content that an entity is directly subscribed to or has directly generated is considered. In FIG. 1, content associated with an entity is depicted with solid one sided arrows, and the content within the aggregated feed for Entity 100 is depicted with dotted double sided arrows.

Hence, an aggregated feed created for Entity 105 (with attribute value combination of School Y and Company X) comprises content that is associated with entities that have at least one of the attribute values from School Y and Company X. In accordance with FIG. 1, Entity 115 has attribute value School Y and Entity 100 and Entity 120 have attribute value ‘Company X’. The aggregated feed for Entity 105 will thus include Content 150, Content 155, Content 160 and Content 165.

Turning now to FIG. 3, a block diagram of Machine 170 for automatically generating one or more aggregated feeds within the network is shown in accordance with an embodiment of the present invention. Machine 170 from FIG. 1 can comprise a plurality of components. The plurality of components can include hardware, software or a combination of hardware and software. The plurality of components can broadly be grouped into system modules including, but not limited to, a Central Processing Unit 305, a Memory 310, an Entity Data System 315, a Content System 320, a Feed Aggregator System 325 and a Feed Display System 330.

Entity Data System 315 in conjunction with Central Processing Unit 305 and Memory 310 is configured to accept one or more attribute values for one or more attributes of entities within the network. Those skilled in the art will realize that the attribute values of an entity can be acquired at the time of registration with the network, or from other affiliated networks, or during subscription. As mentioned earlier, the attributes can include, but are not limited to, personal attributes of an entity, geographical attributes of an entity, educational attributes of an entity, group attributes of an entity, work attributes of an entity, skill attributes of an entity and interest attributes of an entity. Entity data system 315 stores the attribute values of the entities within the network. Entity data system 315 can store the attribute values against an entity ID of an entity.

Content System 320 in conjunction with Central Processing Unit 305 and Memory 310 is configured to accept one or more content associated with the entities in the network. As mentioned in conjunction with FIG. 1, each entity in the network can be subscribed to or can generate content. All such content is accepted and stored by Content System 320. Content System 320 can store this content against an entity ID of the entity with whom the content is associated. Those skilled in the art will realize that each content can be stored against one or more entity IDs, depending on the number of entities subscribed to the content.

Feed Aggregator System 325 in conjunction with Central Processing Unit 305, Memory 310, Entity Data System 315 and Content System 320 is configured to form one or more aggregated feeds for an entity within the network. The aggregated feed for an entity comprises one or more content that is relevant to that entity. For this, Feed Aggregator System 325 creates one or more attribute value combinations from all the attribute values stored by Entity Data System 315. Each attribute value combination comprises a unique combination of attribute values. The combinations of attribute values are explained in detail in conjunction with FIG. 2 above.

Feed Aggregator System 325 then selects an attribute value combination and generates an aggregated feed for that attribute value combination. For generating the aggregated feed, Feed Aggregator System 325 determines one or more content associated with entities that have at least one attribute value from the attribute value combination and adds this content to the aggregated feed.

For instance, for the attribute value combination of School X, Interest X and Company X, Feed Aggregator System 325 determines that entity 105 has the attribute value Company X. Hence, Feed Aggregator System 325 adds Content 125, Content 130 and Content 135 to the aggregated feed for the attribute value combination of School X, Interest X and Company X. Similarly, Feed Aggregator System 325 determines that Entity 110 has the attribute value Interest X, and hence adds Content 140 and Content 145 to the aggregated feed. Entity 120 has all the three attribute values, namely, School X, Interest X and Company X, and hence Feed Aggregator System 325 adds Content 160 and Content 165 to the aggregated feed.

Feed Aggregator System 325 thus generates an aggregated feed comprising Content 125, Content 130, Content 135, Content 140, Content 145, Content 160 and Content 165 for the attribute value combination of School X, Interest X and Company X.

In accordance with one embodiment, Feed Aggregator System 325 generates the aggregated feed every predetermined time period. In another embodiment of the present invention, Feed Aggregator System 325 forms an aggregated feed in response to Content System 320 adding or storing one or more new or updated content. In yet another embodiment, Feed Aggregator System 325 generates the aggregated feed at the request of an entity.

Those skilled in the art will appreciate that the aggregated feed can be created at any point in time or dynamically and all such embodiments are within the scope of the present invention.

Machine 170 further comprises Feed Display System 330, which in conjunction with Central Processing Unit 305, Memory 310, Entity Data System 315, Content System 320 and Feed Aggregator System 325, is configured to display an aggregated feed to an entity within the network.

In an embodiment of the present invention, Feed Display System 330 is configured to receive a request from an entity to display the aggregated feed. In this embodiment, Feed Aggregator System 325 can form the aggregated feed only when Feed Display System 330 receives a request for aggregated feed from an entity. In another embodiment, Feed Aggregator System 325 can create the attribute value combinations in advance, and generate the feed in response to receiving a request from an entity.

An entity can opt to receive aggregated feed for any of the attribute value combinations, or an aggregated feed relevant to the entity based on the attribute values of the entity can be displayed to the entity.

Feed Display System 330 can display the aggregated feed within a browser window of Entity 100 or alongside the browser, as a separate window. Alternately, Feed Display System 330 can display the aggregated feed as hyperlinks of the content within the aggregated feed.

In an embodiment of the present invention, Machine 170 further comprises a Feed Recommendation System 335. Feed Recommendation System 335 in conjunction with Central Processing Unit 305, Entity Data System 315, Content System 320 and Feed Aggregator System 325 is configured to select relevant feeds from the aggregated feeds for an entity. Relevant feed for an entity can include content associated with entities within the network that have at least one attribute value matching with the attribute values of the entity.

Entity 100 has the attribute value combination of School X, Interest X and Company Y. Hence, Feed Recommendation System 335 selects the aggregated feed comprising Content 125, Content 130, Content 135, Content 140, Content 145, Content 160 and Content 165. Feed Recommendation System 330 then recommends this relevant feed to Entity 100.

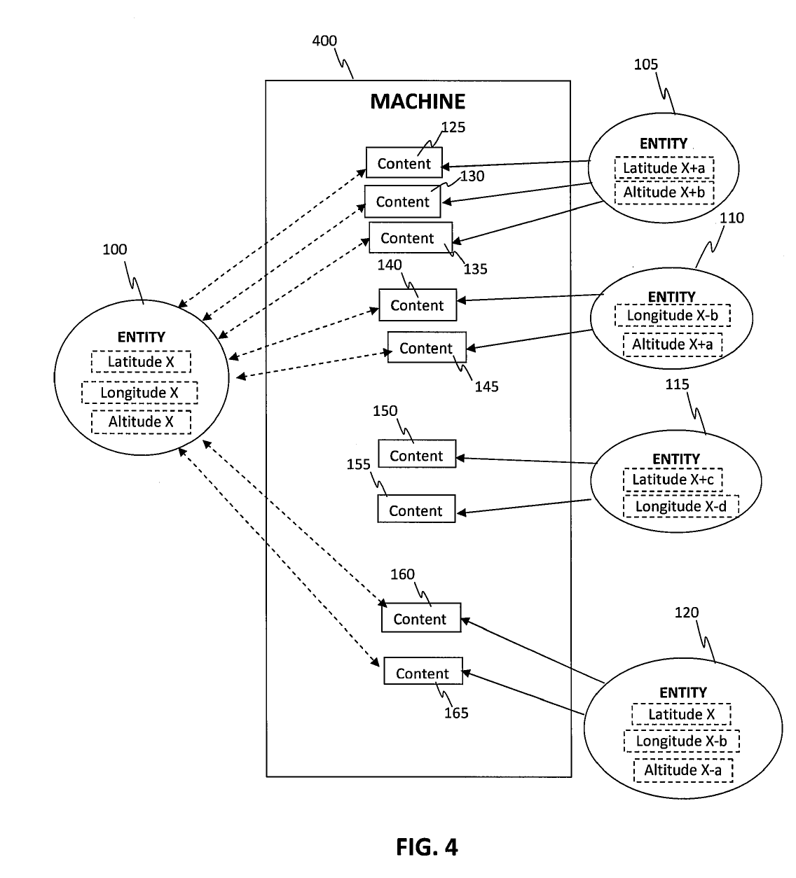

Turning now to FIG. 4, a block diagram of an exemplary environment for automatic generation of a geo-aggregated feed within a network is shown in accordance with various embodiments of the present invention. As mentioned, the network can have a plurality of entities registered with it. An entity, in accordance with the present invention can be, but is not limited to a user, a user group, an organization, a company, a device, an institution or an application.

Similar to FIG. 1, the network in FIG. 4 comprises Entity 100, Entity 105, Entity 110, Entity 115 and Entity 120. Those skilled in the art will appreciate that the network can include a plurality of entities however, only four entities are shown in FIG. 4 for the sake of clarity. Each entity can have various location attributes associated with it. For instance, at any point in time an entity can have certain longitude, latitude and altitude associated with it. The attribute values of these location attributes can dynamically change based on the movement of the entity. Alternately, the attribute values of the location attribute can be constant, based on a permanent location mentioned by the entity.

Further, each location attribute can have more than one attribute values for a particular entity. For instance, the entity can have location attributes for the entity's home address, work address or the location of the entity at a particular point in time.

In accordance with FIG. 4, Entity 100 has attribute values ‘Latitude X’, ‘Longitude X’ and ‘Altitude X’ associated with it. Similarly, Entity 105 has attribute values ‘Latitude X+a’ and ‘Altitude X+d’ associated with it. Entity 110 has attribute values ‘Longitude X-b’ and ‘Altitude X+c’ associated with it. Entity 115 has attribute values ‘Latitude X+c’ and ‘Longitude X-d’ associated with it. Entity 120 has attribute values ‘Latitude X’, ‘Longitude X-b’ and ‘Altitude X-d’ associated with it.

Further, as mentioned earlier, each entity in the network can have various contents associated with it. For instance, an entity can either publish or subscribe to content in the form of a microblog post, a blog post, an update, a file upload, a comment, a photo, a media file, a presentation, a document, a message, an application and a news feed.

Those skilled in the art will appreciate that an entity may be associated with content that is relevant to the location of that entity. The present invention enables the network to automatically determine content that an entity might be interested in and displays this content in the form of a geo-aggregated feed to that entity.

As mentioned in FIG. 1, Entity 105 can have Content 125, Content 130 and Content 135 associated with it. For instance, Content 125 can be a blog post of Entity 105, Content 130 a news feed that Entity 105 subscribes to and Content 135 can be photos uploaded by Entity 105. Similarly, Entity 110 can have Content 140 and Content 145 associated with it. For instance, Content 140 can be an application used by Entity 110 and Content 145 can be a message posted by Entity 110. Entity 115 can have Content 150 and Content 155 associated with it. Content 150 can be a news feed that Entity 115 is subscribed to and Content 155 can be a video uploaded by Entity 115. Entity 120 can have Content 160 and Content 165 associated with it. Content 160 can be a video clip recommended by Entity 120 and content 165 can be a weather report subscribed to by Entity 120.

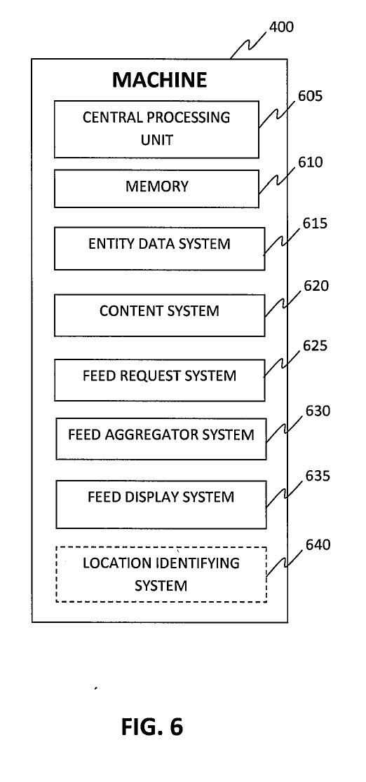

In accordance with the present invention, a Machine 400 is configured to automatically detect content that is relevant to Entity 100 from Content 125, Content 130, Content 135, Content 140, Content 145, Content 150, Content 155, Content 160 and Content 165. Various components of Machine 400 are described below in detail in conjunction with FIG. 6.

In accordance with an embodiment of the present invention, an entity requests Machine 400 for a geo-aggregated feed that is relevant to the entity's current location, entity's permanent location, or any location mentioned by the entity.

For instance, to make the geo-aggregated feed available to Entity 100, Machine 400 determines one or more entities within the network whose location attribute values match the location attribute values of Entity 100 or are within a predetermined distance from the location of Entity 100. Machine 400 then aggregates content that the one or more entities are associates with.

For example, Machine 400 can aggregate a geo-aggregated feed for Entity 100 based on the current location of Entity 100. It will be appreciated that Machine 400 can aggregate geo-aggregated feed for any location specified by Entity 100 or any location mentioned in a profile of Entity 100. Machine 400 or Entity 100 can specify a predetermined distance, and any entity within that predetermined distance is identified as being ‘close’ to the Entity location.

Consider that distances of ‘a’ units and ‘b’ units is within the predetermined distance from the current location of Entity 100 and distances of ‘c’ units and ‘d’ units is beyond the predetermined distance. Those skilled in the art will know that Entity 105, Entity 110 and Entity 120 are within the predetermined distance from Entity 100 and Entity 115 is beyond the predetermined distance from Entity 100.

Hence, in accordance with the present invention, Machine 400 aggregates Content 125, Content 130, Content 135, Content 140, Content 145, Content 160 and Content 165 into a geo-aggregated feed for Entity 100, which is rendered to Entity 100 on its display device.

In one embodiment of the present invention, Machine 400 considers content to be relevant to Entity 100 if more than one location attribute value is shared between Entity 100 and other entities.

In another embodiment of the present invention, Machine 400 orders content in the aggregated feed by a degree of relevance. The degree of relevance is calculated based on weightages given to each attribute and the number of attribute values shared between an entity and Entity 100. For instance, if the Longitude attribute has weightage 10, the Latitude attribute has weightage 5 and the Altitude attribute has weightage 1, then Machine 400 determines Entity 120 to have the highest weightage, Entity 110 to have the second highest weightage and Entity 105 to have the third highest weightage. Hence, content in the aggregated feed is ordered as Content 160, and Content 165, followed by Content 140 and Content 145, followed by Content 125, Content 130 and Content 135.

Those skilled in the art will appreciate that Machine 400 can consider any combination of attributes and weightages to calculate relevance of any content to Entity 100 and all such combinations and deviations are within the scope of the present invention.

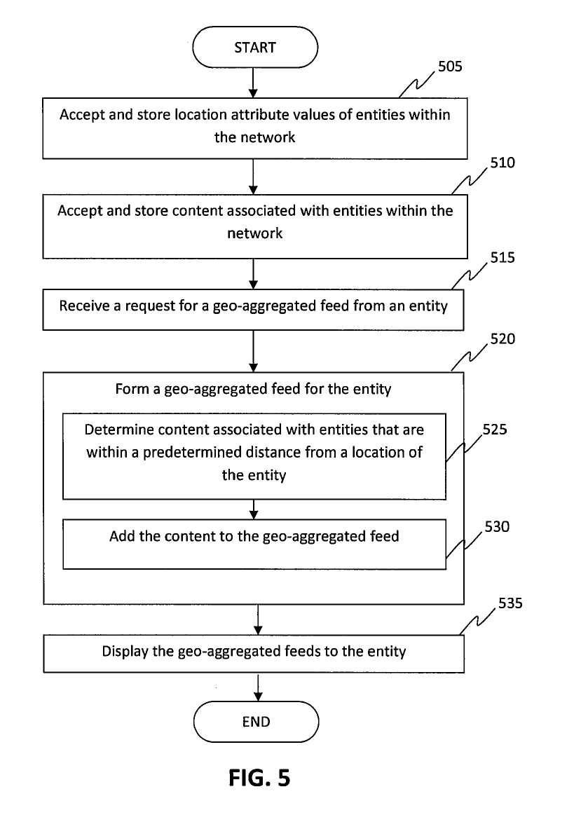

Turning now to FIG. 5, a flow diagram of a method for automatically generating a geo-aggregated feed within the network is shown in accordance with an embodiment of the present invention. As mentioned in conjunction with FIG. 4 above, an entity within the network can have various location attributes associated with it. Location attribute values for location attributes are accepted from entities within the network and these attribute values are stored at step 505.

Location attribute can be, but are not limited to, longitude, latitude and altitude of a location associated with the entity. Those skilled in the art will realize that a plurality of locations can be associated with an entity. Some examples of locations of an entity are the current location of the entity, a word address of the entity, a home address of the entity, etc. Location attributes of all such locations can be accepted and stored.

In accordance with an embodiment of the present invention, each entity has an entity ID within the network. The location attribute values for a particular entity are stored against that entity's entity ID. For instance, Entity 100 can have entity ID ‘XYZ123’ within the network. Location attribute values associated with Entity 100 can be stored against this ID ‘XYZ123’. Hence, attribute value ‘Latitude X’ for the ‘Latitude’ attribute, attribute value ‘Longitude X’ for the ‘Longitude’ attribute and attribute value ‘Altitude X’ for the ‘Altitude’ attribute are stored against the entity ID ‘XYZ123’.

Those skilled in the art will appreciate that location attribute values can be stored using any method known in the art and all such methods are within the scope of the present invention.

At step 510, one or more content associated with entities within the network are accepted and stored. Those skilled in the art will appreciate that, one or more content IDs can be stored instead of storing the one or more content so as to optimize memory space usage.

In accordance with an embodiment of the present invention, the one or more content are stored against the entity IDs. For instance, if Entity 105 has an entity ID ‘ABC123’, then Content 125, Content 130 and Content 135 can be stored against the entity ID ‘ABC123’. It will be appreciated that a content can have more than one entity associated with it, depending on the number of entities that are subscribed to or generate the content.

At step 515, a request for a geo-aggregated feed is received from an entity within the network. In an embodiment of the present invention, the request comprises a location that the entity wants the geo-aggregated feed for and the predetermined distance from the location that defines a circumference around the location. The predetermined distance can be different for different location attributes. For instance, the predetermined distance for Latitude attribute can be set at ‘p’ units, the predetermined distance for Longitude attribute can be set at ‘q’ units and the predetermined distance for Altitude attribute can be set at ‘r’ units. The entity can pass all .such predetermined distances along with the request for geo-aggregated feed. For the sake of simplicity, the embodiment below considers only one predetermined distance for all the location attributes.

In an embodiment of the present invention, the request may not include either a location or a predetermined distance. By default, the current location of the entity and a default predetermined distance is considered. The default location can be set by each entity individually and a geo-aggregated feed can be formed for that default location.

At step 520, a geo-aggregated feed is formed for the entity. A geo-aggregated feed comprises content aggregated from entities that are within the predetermined distance from the location of the entity.

Forming a geo-aggregated feed for an entity comprises determining content associated with entities that are within the predetermined distance from the location of the entity, at step 525. For instance, referring back to FIG. 4, if distances of ‘a’ units and ‘b’ units are within the predetermined distance and distances of ‘c’ units and ‘d’ units are outside of the predetermined distance of the location of the entity, then Entity 105, Entity 110 and Entity 120 are identified to be within the predetermined distance of the location of the entity and Entity 115 is identified to be outside the predetermined distance from the location of the entity.

Content associated with Entity 105, Entity 110 and Entity 120 is determined at step 525 and is added to the geo-aggregated feed for the entity at step 530. In accordance with FIG. 5, Content 125, Content 130, Content 135, Content 140, Content 145, Content 160 and Content 165 are determined and added to the geo-aggregated feed for Entity 100. Those skilled in the art will realize that instead of the content itself, a marker or a content ID of the content can be added to the geo-aggregated feed.

In one embodiment of the present invention, an entity is given an option to subscribe or unsubscribe from the geo-aggregated feed and the geo-aggregated feed is automatically rendered to the entity device dynamically. In another embodiment, an entity is given one or more filter options for receiving the geo-aggregated feed. The one or more filter options include, but are not limited to, filtering the geo-aggregated feed by at least one entity type, filtering the geo-aggregated feed by at least one entity, and filtering the geo-aggregated feed by at least one type of content. Entity type includes, but is not limited to, a user, a user group, an organization, a company, a device and an application.

In another embodiment of the present invention, content included in the geo-aggregated feed has one or more permissions attached. The one or more permissions can allow or disallow an entity or an entity group to view the content. Any content that an entity does not have permission to view, is filtered out from the geo-aggregated feed.

In an embodiment of the present invention, content in the geo-aggregated feed is ordered in terms of priority either specified by the entity or a default priority. The priority can be based on the closeness of the entities from whom the content is aggregated to the location of the entity.

Those skilled in the art will realize that many such embodiments to prioritize and filter the geo-aggregated feed can be derived, and all such embodiments are within the scope of the present invention.

At step 535, the geo-aggregated feed is displayed to the entity. In accordance with the exemplary embodiment depicted in FIG. 4, a geo-aggregated feed comprising Content 125, Content 130, Content 135, Content 140, Content 145, Content 160 and Content 165 is displayed to Entity 100.

The geo-aggregated feed can be displayed within a browser window of Entity 100 or alongside the browser, as a separate window. Alternately, the geo-aggregated feed can also be displayed as hyperlinks of the content within the geo-aggregated feed.

Those skilled in the art will appreciate that the geo-aggregated feed being displayed to an entity does not indicate that the content within the geo-aggregated feed is ‘associated’ with the entity. Hence, while generating an aggregated feed, only the content that an entity is directly subscribed to or has directly generated is considered. Else, in a large network with a plurality if entities, geo-aggregated feed for an entity may comprise a lot more content than required. In FIG. 4, content associated with an entity in depicted with one sided arrows, and the content within the geo-aggregated feed for Entity 100 is depicted with double sided arrows.

Turning now to FIG. 6, a block diagram of Machine 400 for automatically generating geo-aggregated feed for an entity within the network is shown in accordance with an embodiment of the present invention. Machine 400 from FIG. 4 and Machine 170 from FIG. 1 can be one single machine or can be different machines.

Machine 400 can comprise a plurality of components. The plurality of components can include hardware, software or a combination of hardware and software. The plurality of components can broadly be groups into system modules including, but not limited to, a Central Processing Unit 605, a Memory 610, an Entity Data System 615, a Content System 620, a Feed Request System 625, a Feed Aggregator System 630 and a Feed Display System 635.

Entity Data System 615 in conjunction with Central Processing Unit 605 and Memory 610 is configured to accept one or more location attribute values of entities within the network. The location attribute values of an entity can correspond to a current location of the entity or any other location associated with the entity. The current location of the entity can be determined using, but not limited to, a Global Positioning System (GPS), an altimeter etc.

Those skilled in the art will realize that locations associated with an entity, such as office location, home location, etc can be acquired at the time of registration with the network, or from other affiliated networks, or during subscription. As mentioned earlier, the location attributes can include, but are not limited to, latitude of an entity, longitude of an entity and altitude of an entity. Entity Data System 615 then stores the location attribute values of the entities within the network. Entity Data System 615 can store the location attribute values against an entity ID of an entity.

Content System 620 in conjunction with Central Processing Unit 605 and Memory 610 is configured to accept one or more content associated with the entities in the network. As mentioned in conjunction with FIG. 4, each entity in the network can be subscribed to or can generate content. All such content is accepted and stored by Content System 620. Content System 620 stores this content against an entity ID of the entity with whom the content is associated. Those skilled in the art will realize that each content can be stored against one or more entity IDs, depending on the number of entities subscribed to the content.

Feed Request System 625 is configured to receive a request from an entity within the network for a geo-aggregated feed. For example, Feed Request System 625 can receive a request from Entity 100. The request may be an on-the-fly request or part of the entity's subscription to the geo-aggregated feed.

The request may include a location of the entity and a predetermined distance. The location of the entity may not be mentioned by the entity, in which case, Machine 400 considers a default location for the entity, namely, the current location of the entity or any location associated with the entity. The entity can be given an option to choose a default location. Similarly, the predetermined distance may not be included in the request, in which case a default predetermined distance is considered. The entity can be given an option to select the predetermined distance or Machine 400 can set a predetermined distance at a system level. Also, as mentioned earlier, there can be different predetermined distances for each of the location attributes.

Feed Aggregator System 630 in conjunction with Central Processing Unit 605, Memory 610, Entity Data System 615, Content System 620 and Feed Request System 625 is configured to form a geo-aggregated feed for an entity within the network. The geo-aggregated feed for an entity comprises one or more content associated with entities that are close to a location of the entity, that is, content associated with entities that are within the predetermined distance of the location of the entity.

For this, Feed Aggregator System 630 identifies all entities that are within the predetermined distance from the location of the entity. Assuming that distances of ‘a’ units and ‘b’ units are within the predetermined distance from the location of the entity and distances of ‘c’ units and ‘d’ units are outside the predetermined distance from the location of the entity. Feed Aggregator System 630 identifies that Entity 105 with Latitude X+a and Altitude X+b, Entity 110 with Longitude X-b and Altitude X+a, Entity 120 with Latitude X, Longitude X-b and Altitude X-a are within the predetermined distance from Entity 100.

Feed Aggregator System 630 determines content associated with the entities within the predetermined distance from Entity 100. Hence, Feed Aggregator System 630 determines Content 125, Content 130, Content 135, Content 140, Content 145, Content 160 and Content 165 as being geo-targeted for Entity 100. This content is added to the geo-aggregated feed for Entity 100.

In accordance with one embodiment, Feed Aggregator System 630 forms the geo-aggregated feed every predetermined time period for Entity 100. In another embodiment of the present invention, Feed Aggregator System 630 forms the geo-aggregated feed in response to Content System 620 adding or storing one or more content.

Those skilled in the art will appreciate that the aggregated feed can be created at any point in time or dynamically and all such embodiments are within the scope of the present invention. Feed Aggregator System 630 can dynamically keep updating the content based entities moving in and out of the predetermined distance from the location of Entity 100.

Feed Display System 635 in conjunction with Central Processing Unit 605, Memory 610, Entity Data System 615, Content System 620, Feed Request System 625 and Feed Aggregator System 630 is configured to display the geo-aggregated feed to Entity 100.

In an embodiment of the present invention, Feed Aggregator System 630 can form the geo-aggregated feed proactively without receiving a request from Entity 100 and Feed Display System 635 can display the geo-aggregated feed by default to all the entities within the network.

Feed Display System 635 can display the geo-aggregated feed within a browser window of Entity 100 or alongside the browser, as a separate window. Alternately, Feed Display System 635 can display the geo-aggregated feed as hyperlinks of the content within the geo-aggregated feed.

In an embodiment of the present invention, Content System 620 is configured to accept permissions attached to each content, such that the permissions either allow or disallow certain entities or entity groups to view or access the content. Feed Display System 635 is configured to filter out any content that Entity 100 is denied access to from the geo-aggregated feed.

In an embodiment of the present invention, Feed Display System 635 is further configured to receive a filter option from an entity. The filter options can comprise, but are not limited to, filtering by location attribute, filtering by entity type, filtering by at least one entity and filtering by type of content.

In an embodiment of the present invention, Machine 400 further comprises a Location Identifying System 640. Location Identifying System 640 is configured to identify the location of entities within the network. The location of an entity can be a current location of the entity or any location associated with the entity. Location Identifying System 640 automatically identifies location attribute values for the location of the entity. For example, Location Identifying System 640 can have a GPS or an altimeter to determine the current location of an entity. Location Identifying System 640 can also comprise a mechanism to determine latitude, longitude and altitude of any location associated with an entity.

Various embodiments of the present invention describe method and machine to automatically generate an aggregated feed or a geo-aggregated feed for an entity with a network such that content within the aggregated feed is relevant to the entity and content within the geo-aggregated feed is geographically targeted to the entity. By the virtue of the present embodiment, an entity within the network is saved the effort to manually subscribe to content that interests the entity. The proposed invention enables automatic detection of what the entity might be interested in and renders any content accordingly to a device of the entity.

What is claimed is:

1. A machine for automatically generating one or more aggregated feeds within a network, the network comprising of one or more entities, the machine comprising one or more connected components, the one or more connected components comprising:
a central processing unit;
a memory;
an entity data system, the entity data system in conjunction with the central processing unit and the memory configured to:
accept one or more attribute values for one or more attributes of an entity within the network, wherein the one or more attributes comprise one or more of:
one or more personal attributes of the entity,
one or more geographical attributes of the entity,
one or more educational attributes of the entity,
one or more group attributes of the entity,
one or more work attributes of the entity,
one or more skill attributes of the entity, and
one or more interest attributes of the entity; and
store the one or more attribute values of the entity;
a content system, the content system in conjunction with the central processing unit and the memory configured to:
accept one or more content associated with the one or more entities; and
store the one or more content;
a feed aggregator system, the feed aggregator system in conjunction with the central processing unit, the memory, the entity data system and the content system configured to form the one or more aggregated feeds, wherein the forming step comprises:
creating one or more attribute value combinations, each attribute value combination comprising a unique combination of one or more attribute values;
selecting a first attribute value combination from the one or more attribute value combinations;
generate a first aggregated feed, the first aggregated feed belonging to the one or more aggregated feeds, the first aggregated feed corresponding to the first attribute value combination, wherein the generating step comprises:
determining one or more first content belonging to the one or more content, the one or more first content being associated with an entity having at least one attribute value matching with at least one attribute value of the first attribute value combination; and
adding the one or more first content to the first aggregated feed; and
a feed display system, the feed display system in conjunction with the central processing unit, the feed aggregator system, the content system and the entity data system configured to display at least one aggregated feed, the at least one aggregated feed belonging to the one or more aggregated feeds.

2. The machine of claim 1, wherein the machine further comprises a feed recommendation system, the feed recommendation system in conjunction with the central processing unit, the entity data system, the content system and the feed aggregator system configured to:
select one or more relevant feeds from the one or more aggregated feeds for a first entity, wherein one or more attribute value combinations corresponding to the one or more relevant feeds comprises at least one attribute value of the first entity, wherein the first entity belongs to the one or more entities; and
recommend the one or more relevant feeds to the first entity.

3. The machine of claim 1, wherein the feed display system is configured to receive a request from an entity to display the at least one aggregated feed.

4. The machine of claim 3, wherein the feed aggregator system performs one or more of the forming step and the generating step in response to the feed display system receiving the request.

5. The machine of claim 1, wherein the feed aggregator system performs one or more of the forming step and the generating step, in response to the content system one or more of accepting the one or more content and storing the one or more content.

6. The machine of claim 1, wherein the feed aggregator system performs one or more of the forming step and the generating step at every predetermined time period.

7. The machine of claim 1, wherein the one or more personal attributes comprise one or more combinations of:
one or more names of the entity,
an age of the entity,
a birthday of the entity,
a gender of the entity,
a nationality of the entity,
one or more websites of the entity,
one or more Instant messenger details of the entity
one or more email address of the entity, and
one or more relationship status of the entity.

8. The machine of claim 1, wherein the one or more geographical attributes comprise one or more combinations of:
one or more countries of the entity,
one or more states of the entity,
one or more cities of the entity,
one or more suburbs of the entity,
one or more streets of the entity,
one or more pin codes of the entity,
one or more of latitude, longitude and altitude of the entity, and
one or more buildings of the entity.

9. The machine of claim 1, wherein the one or more educational attributes comprise one or more combinations of:
one or more qualifications of the entity,
one or more schools of the entity,
one or more classes corresponding to the one or more schools of the entity, and
one or more degrees of the entity.

10. The machine of claim 1, wherein the one or more group attributes of the entity comprise one or more combinations of:
one or more groups in the network, the entity being subscribed to the one or more groups.

11. The machine of claim 1, wherein the one or more work attributes of the entity comprise one or more combinations of:
one or more companies of the entity,
one or more geographical attributes of the one or more companies of the entity,
one or more departments of the one or more companies of the entity, and
one or more industries related to the entity.

12. The machine of claim 1, wherein the one or more interest attributes of the entity comprise one or more interests of the entity.

13. The machine of claim 1, wherein the one or more skill attributes comprises one or more specializations of the entity.

14. The machine of claim 1, wherein the entity is one or more of a user, a user group, an organization, a company, a device and an application.

15. The machine of claim 1, wherein the one or more content comprises one or more of a microblog post, a blog post, an update, a file upload, a comment, an application, a news feed, a photo, a media file, a presentation, a document and a message.

16. The machine of claim 1, wherein the content system is further configured to accept one or more permissions attached to the one or more content associated with the one or more entities.

17. The machine of claim 16, wherein the feed display system is configured to filter out zero or more first content from the one or more aggregated feed, wherein the entity is denied permission to access the zero or more first content.

18. The machine of claim 1, wherein the feed display system is configured to give an entity an option to one or more of subscribe and unsubscribe to the one or more aggregated feeds.

19. The machine of claim 1, wherein the feed display system is configured to display the at least one aggregated feed to an entity as at least one of within and alongside a browser window.

20. The machine of claim 1, wherein the feed display system is configured to display one or more hyperlinks corresponding to the at least one aggregated feed to an entity.

21. The machine of claim 1, wherein the feed display system is further configured to receive a filter option from an entity, wherein the filter option belongs to one or more filter options, the one or more filter options comprising:
filtering by at least one attribute,
filtering by at least one entity type,
filtering by at least one entity, and
filtering by at least one type of content.

22. A machine for automatically generating a geo-aggregated feed within a network, the network comprising of one or more entities, the machine comprising one or more connected components, the one or more connected components comprising:
a central processing unit;
a memory;
an entity data system, the entity data system in conjunction with the central processing unit and the memory configured to:
accept one or more location attribute values of an entity, and
store the one or more location attribute values of the entity;
a content system, the content system in conjunction with the central processing unit and the memory configured to:
accept one or more content associated with the one or more entities; and
store the one or more content;
a feed request system, the feed request system configured to receive a request for a geo-aggregated feed from a first entity, the first entity belonging to the one or more entities;
a feed aggregator system, the feed aggregator system in conjunction with the central processing unit, the memory, the entity data system and the content system configured to form the geo-aggregated feed for the first entity, wherein the forming step comprises:
determining one or more first content from the one or more content, the one or more first content being associated with at least one second entity, the at least one second entity being within a predetermined distance from a first location; and
adding the one or more first content to the geo-aggregated feed; and
a feed display system, the feed display system in conjunction with the central processing unit, the memory, the entity data system, the content system, the feed request system and the feed aggregator system configured to display the geo-aggregated feed to the first entity.

23. The machine of claim 22, wherein the request comprises one or more of a first location and the predetermined distance, wherein the first location is one or more of a current location of the first entity and a location associated with the first entity.

24. The machine of claim 22, wherein the one or more location attributes and the first location comprise one or more of a latitude, a longitude and an altitude

25. The machine of claim 22 further comprises a location identifying system, the location identifying system configured to identify automatically one or more of the one or more location attribute values of the first location.

26. The machine of claim 22, wherein the content system is further configured to accept one or more permissions attached to the one or more content associated with the one or more entities.

27. The machine of claim 26, wherein the feed display system is configured to filter out zero or more first content from the geo-aggregated feed, wherein the entity is denied permission to access the zero or more first content.

28. The machine of claim 22, wherein the feed display system is configured to display the geo-aggregated feed to an entity as at least one of within and alongside a browser window.

29. The machine of claim 22, wherein the feed display system is configured to display one or more hyperlinks corresponding to the geo-aggregated feed to an entity.

30. The machine of claim 22, wherein the feed display system is further configured to receive a filter option from the first entity, wherein the filter option belongs to one or more filter options, the one or more filter options comprising:
filtering by at least one location attribute,
filtering by at least one entity type,
filtering by at least one entity, and
filtering by at least one type of content.
